(19) United States
(12) Patent Application Publication
(10) Pub. No.: US 2022/0138813 A1
(43) Pub. Date: May 5, 2022

(54) System and Method of Analyzing Changes in User Ratings

(71) Applicant: MICROSOFT TECHNOLOGY LICENSING, LLC, Redmond, WA (US)

(72) Inventors: Manoj Kumar RAWAT, Bellevue, WA (US); Orens XHAGOLLI, Redmond, WA (US); Sathia Prabhu THIRUMAL, Bothell, WA (US)

(73) Assignee: MICROSOFT TECHNOLOGY LICENSING, LLC, Redmond, WA (US)

(21) Appl. No.: 17/085,158

(22) Filed: Oct. 30, 2020

(51) Int. Cl. G06Q 30/02; G06Q 10/06; G06F 16/22

(52) U.S. Cl. CPC G06Q 30/0282; G06Q 30/0201; G06F 9/451; G06Q 30/0203; G06F 16/2264; G06Q 10/0637

(57) ABSTRACT

A method and system for displaying changes in user ratings may include receiving a request to calculate a value for an amount of change in a parameter associated with user ratings between a first time period and a second time period, retrieving data from a data structure associated with the user ratings, the data structure including a plurality of dimensions for each user rating and each dimension having one or more levels, calculating based on the retrieved data the value for the amount of change for at least one of the plurality of dimensions, quantifying, for the calculated value, a first portion resulting from changes in user population and a second portion resulting from true change in the parameter associated with user ratings, and providing display data for generating a user interface (UI) screen to display at least one of the calculated value, the first portion and the second portion on a display device.

CROSS-REFERENCE TO A RELATED APPLICATION

This patent application is related to co-pending, commonly-owned U.S. patent application Ser. No. (not yet assigned) entitled “System and Method of Analyzing Significant Changes in User Ratings,” filed concurrently herewith under Attorney Docket No. 409043-US-NP/170101-677, which is incorporated herein by reference in its entirety.

### TECHNICAL FIELD

This disclosure relates generally to multidimensional analysis of changes in user ratings, and, more particularly, to a method of and system for analyzing changes in user ratings over multiple dimensions and providing the changes for display.

### BACKGROUND

Enterprises often rely on user ratings to measure customer satisfaction and identify areas for improvement. One of the most commonly utilized user rating schemes is the Net Promotor Score (NPS). The NPS offers a simple mechanism for measuring customer satisfaction. To calculate the NPS, users are offered a rating scale (e.g., a scale of 0 to 5 or a scale of 0 to 10) to rate a company, service, or product. The rating is representative of the likelihood of the user recommending the company, service or product to another person. To calculate the NPS, the percentage of users that are unlikely to recommend the company, service or produce (e.g., those providing a rating score of 0 to 6 on a scale of 0 to 10) is deducted from the percentage of users that are highly likely to promote the company, service or product (e.g. those with scores of 9 or 10 on a scale of 0 to 10).

In addition to reviewing the recent NPS scores, it is sometimes useful for enterprises to monitor how user ratings change over time. To achieve this, changes in NPS within different time periods may be calculated and monitored. The changes may then be used to assess how recent changes (e.g., new product features, new locations, and the like) have affected customer satisfaction, which direction the market is moving towards, and the like. These determinations may be used in making important business decisions, such as which product features or services to offer in the future, what improvements to make (e.g., based on previous improvements that have resulted in increased NPS) and the like.

However, measurement of NPS often relies on random selection of respondents from the user population. As a result of this random selection, the types of users that are offered the rating scale and/or choose to respond to the survey often changes with time. The change in the respondent population could have a significant impact on the NPS. As a result, a change in NPS may not be representative of actual change in customer satisfaction or the change may not be as significant as the NPS suggests. Thus, changes in the NPS may present an inaccurate and/or simplified picture of customer satisfaction. When such inaccurate representation is used in making consequential business decisions, the result could be costly.

Hence, there is a need for systems and methods of enabling accurate analysis of changes in user ratings over time.

### SUMMARY

In one general aspect, the instant application describes a data processing system having a processor and a memory in communication with the processor wherein the memory stores executable instructions that, when executed by the processor, cause the data processing system to perform multiple functions. The functions may include receiving a request to calculate a value for an amount of change in a parameter associated with user ratings between a first time period and a second time period, retrieving data from a data structure associated with the user ratings, the data structure including a plurality of dimensions for each user rating and each dimension having one or more levels, calculating, based on the retrieved data, the value for the amount of change for at least one of the plurality of dimensions, quantifying, for the calculated value, a first portion resulting from changes in user population proportions and a second portion resulting from true change in the parameter associated with the user ratings, and providing display data for generating a user interface (UI) screen to display at least one of the calculated value, the first portion and the second portion on a display device. Quantifying the first portion may include receiving as an input, for each of the one or more levels of the at least one of the plurality of dimensions, the parameter associated with the user rating at the first time period, a first proportion of user population size at the first time period and a second proportion of user population size at the second time period, calculating for each of the one or more levels of the at least one of the plurality of dimensions, the first portion by taking into account a change in user population size between the first time period and the second time period, and calculating the first portion for the at least one of the plurality of dimensions by taking into the calculated first portion for each of the one or more levels of the at least one of the plurality of dimensions.

In yet another general aspect, the instant application describes a method for displaying changes in user ratings. The method may include receiving a request to calculate a value for an amount of change in a parameter associated with user ratings between a first time period and a second time period, retrieving data from a data structure associated with the user ratings, the data structure including a plurality of dimensions for each user rating and each dimension having one or more levels, calculating based on the retrieved data the value for the amount of change for at least one of the plurality of dimensions, quantifying, for the calculated value, a first portion resulting from changes in user population proportions and a second portion resulting from true change in the parameter associated with the user ratings, and providing display data for generating a UI screen to display at least one of the calculated value, the first portion and the second portion on a display device. Quantifying the first portion may include receiving as an input, for each of the one or more levels of the at least one of the plurality of dimensions, the parameter associated with the user rating at the first time period, a first proportion of user population size at the first time period and a second proportion of user population size at the second time period, calculating for each of the one or more levels of the at least one of the plurality of dimensions, the first portion by taking into account a change in user population size between the first time period and the second time period, and calculating the first portion for the at least one of the plurality of dimensions by taking into the calculated first portion for each of the one or more levels of the at least one of the plurality of dimensions.

In a further general aspect, the instant application describes a non-transitory computer readable medium on which are stored instructions that when executed cause a programmable device to receive a request to calculate a value for an amount of change in a parameter associated with user ratings between a first time period and a second time period, retrieve data from a data structure associated with the user ratings, the data structure including a plurality of dimensions for each user rating and each dimension having one or more levels, calculate based on the retrieved data the value for the amount of change for at least one of the plurality of dimensions, quantify, for the calculated value, a first portion resulting from changes in user population proportions and a second portion resulting from true change in the parameter associated with the user ratings, and providing display data for generating a UI screen to display at least one of the calculated value, the first portion and the second portion on a display device. Quantifying the first portion may include receiving as an input, for each of the one or more levels of the at least one of the plurality of dimensions, the parameter associated with the user rating at the first time period, a first proportion of user population size at the first time period and a second proportion of user population size at the second time period, calculating for each of the one or more levels of the at least one of the plurality of dimensions, the first portion by taking into account a change in user population size between the first time period and the second time period, and calculating the first portion for the at least one of the plurality of dimensions by taking into the calculated first portion for each of the one or more levels of the at least one of the plurality of dimensions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 is an example data set used for collecting and storing NPS data in a given time period.

FIG. 3 is an example graphical user interface (GUI) screen of a data analysis application used to analyze and display customer rating data.

FIG. 4 is an example GUI screens for displaying detailed information about changes in customer ratings within different respondent dimensions.

FIG. 5 is an example GUI screen for displaying detailed information about NPS changes in customer ratings within each individual dimension.

FIG. 6 is a flow diagram depicting an example method for analyzing and presenting changes in respondent ratings.

FIG. 7 is a block diagram illustrating an example software architecture, various portions of which may be used in conjunction with various hardware architectures herein described.

FIG. 8 is a block diagram illustrating components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

User rating mechanisms such as the NPS are widely used by enterprises to measure customer satisfaction. In addition to measuring customer satisfaction at different points in time, enterprises may benefit from evaluating changes in customer satisfaction over time. For example, when a new product feature is offered, it may be important to evaluate changes in customer ratings to determine how the new feature has affected customer satisfaction. Changes in customer ratings may also be indicative of customer trends and whether a product needs to be updated. As a result, changes in NPS may be used in making consequential business decisions.

However, because the types of customers that are offered and/or respond to a survey may change from time to time, changes in NPS may not be an accurate representation of a change in customer satisfaction. This is particularly the case when dealing with a large customer population and/or a customer population that is geographically or otherwise diverse. For example, for a software program that is offered globally, a change in NPS over a given time period may be due to specific demographic changes and types of customers in a specific region of the world rather than true NPS changes. If the software program is offered for the first time in a new language, a decrease in the overall NPS may be more due to new user errors rather than overall decrease in customer satisfaction. The total NPS change does not take into account underlying conditions that may affect the overall change in score. As a result, the change in the total NPS may be an inaccurate representation of change in customer satisfaction. This could lead to costly miscalculations for enterprises that rely on the NPS for their business decisions. Furthermore, because many enterprises have a large and diverse number of respondents, it is difficult to determine how and if the respondent population has changed and whether that change has had an impact on the changes in NPS. That is because although some mechanisms such as decision tree modeling (DTM), random forest and boosted decision tree exist for analyzing drivers of changes, these mechanisms do not decompose the change to account for sample proportion changes for different levels of different categories of users. As a result, these mechanisms cannot accurate and efficiently take into account changes in respondent population and how those changes affect the change in NPS. As such, there exists a technical problem of accurately and efficiently analyzing changes in NPS. Moreover, because of the large number of respondents and numerous ways in which they can be categorized, it is often difficult to present the changes to the user in an easily understandable manner. Thus, there exists another technical problem of presenting complex data analysis to the user in an easily understandable manner to enable the user to review the factors that may be affecting the change in NPS.

To address these technical problems and more, in an example, this description provides a technical solution for analyzing changes in NPS in multiple different customer dimensions and levels, providing a user interface (UI) that enables a user to explore NPD for different dimensions and levels, and identifying and/or displaying dimensions and/or levels where changes in sample population caused NPS changes. To do so, techniques may be used to collect and take into account additional information about users (and/or their devices or products) that respond to a survey. The additional information may be used to categorize the users into different categories. These categories may be referred to as dimensions. In an example, the dimensions include customer type (e.g., consumer or commercial), product version used, country (e.g. United States, Canada, etc.), operating system, device manufacturer and the like. To accurately identify changes in respondent populations that affected the NPS, many different customer dimensions may be used. In an example, for a software program, there are more than a 150 customer dimensions. Each dimension may itself be divided into multiple levels. Changes in NPS may then be calculated for each dimension and each level. For each of those levels and/or dimensions, the portion of the NPS change that is due to changes in the user proportion may be calculated. As a result, an adjusted NPS change which is representative of the true NPS change may be calculated for each dimension and/or level. The changes in NPS (e.g., total NPS change and the adjusted NPS change) at the different dimensions may be displayed in an easily understandable UI to enable a user to review the changes at each dimension and each level. This may enable the user to easily review how the NPS actually changed for various different customer dimensions and levels.

While this may be very useful in analyzing the variables that affect an NPS changes, for enterprises that that have significant number of respondents that fall into numerous categories, it may still take a lot of time and resources to manually review how NPS changes in each dimension to determine whether or not a specific dimension caused a significant change in the total NPS. To address this problem, the technical solution identifies and presents the largest change in NPS at different dimensions and/or levels to enable the user to identify dimensions that influence the change in NPS more.

As will be understood by persons of skill in the art upon reading this disclosure, benefits and advantages provided by such implementations can include, but are not limited to, a technical solution to the technical problems of calculations of changes in customer ratings that do not take into account changes in respondent populations, identifying what changes in respondent populations may have caused changes in user ratings, and presenting the results in an easily understandable and easily navigable manner to the user. Solutions and implementations provided herein optimize the process of evaluating user rating changes and improve both the accuracy of results and the ease of use. This may enable the user to quickly and accurately identify true changes in user ratings and determine how changes in user populations may have caused changes in ratings. Furthermore, the solutions and implementations provided herein simplify the process of determining adjusted NPS changes in one or more dimensions by utilizing simplified calculations. This reduces the amount of processor and memory resources required to make such determinations. The benefits provided by these technology-based solutions yield more accurate and user-friendly mechanisms of analyzing user ratings, and increased system and user efficiency.

As used herein, the terms “customer,” “respondent” and “user” may refer to an individual or entity that responds to a rating survey. Furthermore, as used herein, the term “adjusted NPS change” or “true NPS change” may refer to a change in NPS that is indicative of actual changes in user ratings that is not caused by changes in sample populations.

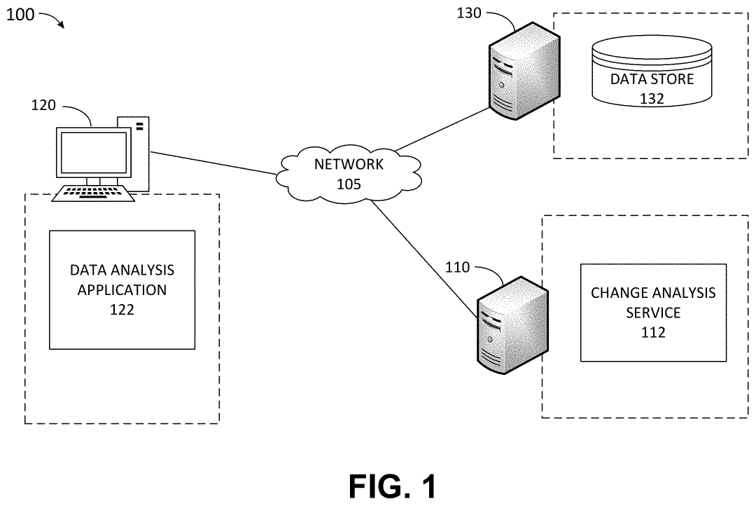

FIG. 1 illustrates an example system 100, upon which aspects of this disclosure may be implemented. The system 100 may include a server 110 which may include and/or execute a change analysis service 112 and a client device 120. The server 110 may operate as a shared resource server located at an enterprise accessible by various computer client devices such as client device 120. The server may also operate as a cloud-based server for offering global change analysis services. Although shown as one server, the server 110 may represent multiple servers for performing various different operations.

The change analysis service 112 may operate as the backend engine for performing change analysis calculations. The change analysis service 112 may operate to receive user input such as selection of two time periods (e.g., two different months) and one or more additional filters, calculate a change in user ratings between the two time periods for one or more dimensions and levels of user data, as further discussed below, and provide the calculated values for display.

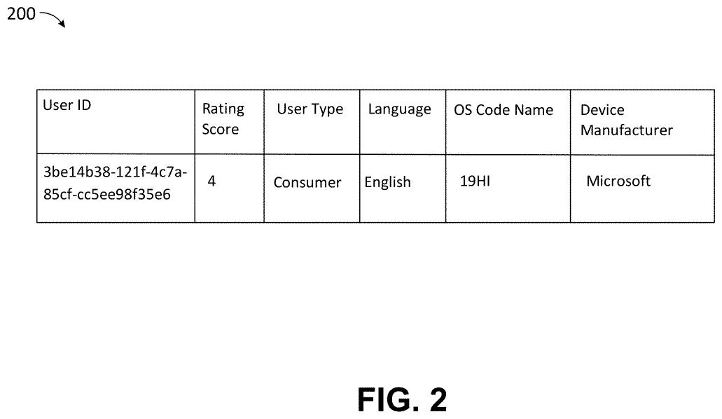

The server 110 may be connected to (e.g., via a network 105) or include a storage server 130 containing a data store 132. The data store 132 may function as a repository in which user rating data is stored. In one implementation, the data may be stored in a columnar format. The user rating data may be divided and stored separately for different time periods. For example, the data may be collected and stored in different data sheets for each month of the year or each date of the month. To ensure that respondent population changes are taken into account when calculating user rating changes, various different dimensional data may also be collected and stored, along with the user rating data, as further discussed below with respect to FIG. 2.

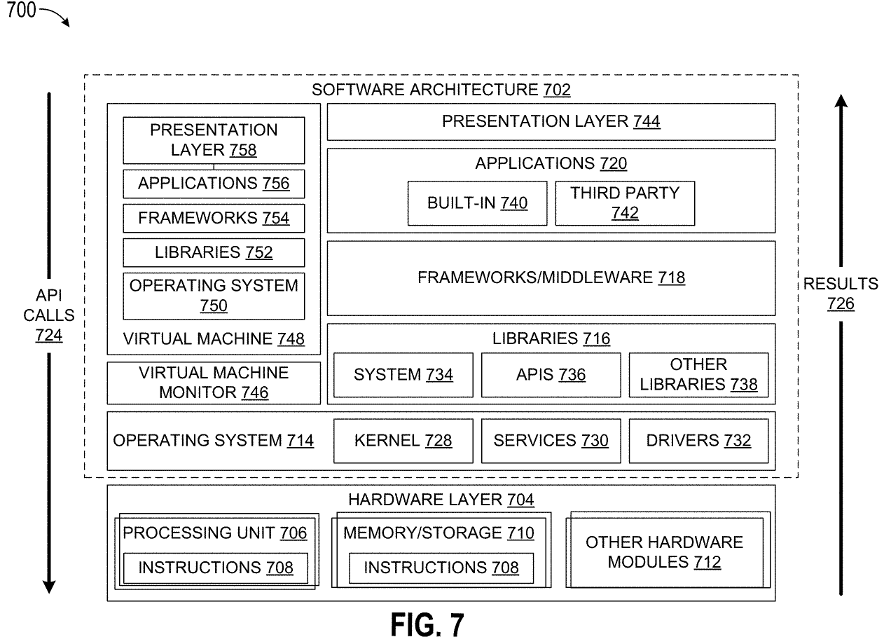

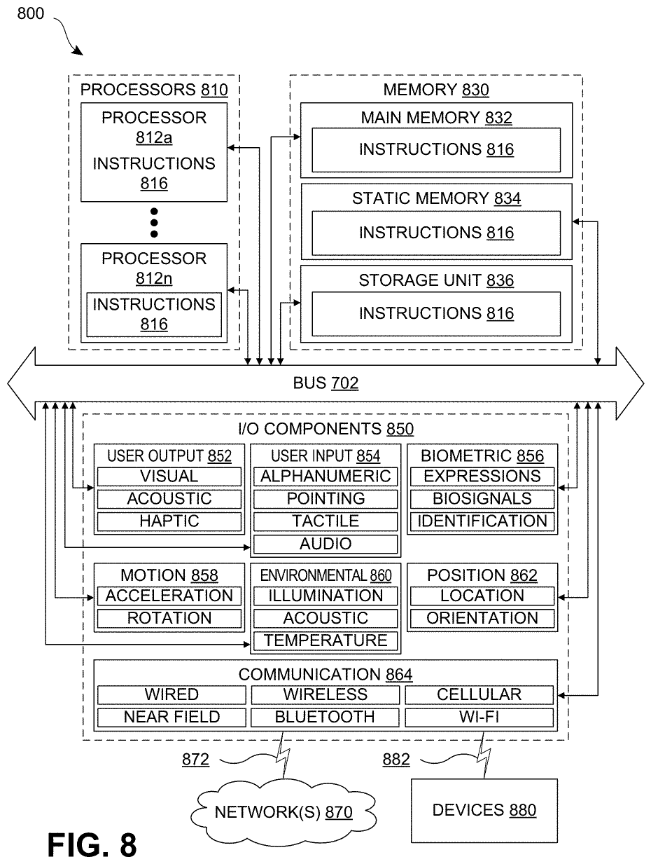

The client device 120 may be connected to the server 110 via the network 105. The network 105 may be a wired or wireless network(s) or a combination of wired and wireless networks that connect one or more elements of the system 100. The client device 120 may be a personal or handheld computing device having or being connected to input/output elements that enable a user to interact with digital content such as a data analysis application on the client device 120. Examples of suitable client devices 120 include, but are not limited to, personal computers, desktop computers, laptop computers, mobile telephones; smart phones; tablets; phablets; smart watches; wearable computers; gaming devices/computers; televisions; head-mounted display devices and the like. The internal hardware structure of a client device is discussed in greater detail in regard to FIGS. 7 and 8.

The client device 120 may include a user data analysis application 122. The user data analysis application 122 may be a computer program executed on the client device 120 that configures the device to be responsive to user input that allows a user to interactively view and/analyze user rating data such as NPS data and changes in NPS over time. The user data analysis application 122 may provide a UI that allows the user to interact with user rating data stored in the data store 132 and/or on the client device 120. The user data analysis application 122 may function as a frontend application for the backend services offered by the change analysis service 112. Thus, the user data analysis application 122 may function as a tool that enables a user to select various filters to view and/or analyze specific user rating data such as the NPS. For example, the user data analysis application 122 may enable the user to select a time period 1 and a time period 2 for viewing the NPS in each of those time periods, for viewing the change in NPS in between those time periods, and/or for viewing the dimensions that had the largest NPS changes between time periods 1 and 2. The user's selections may be transmitted to the change analysis service 112, where the calculations are performed and the results may be transmitted back to the client device 120 to be displayed to the user via a UI of the user data analysis application 122. The client device 120 may also provide access to a user data analysis application (not shown) stored and/or run on a server such as the server 110 and accessed via a user agent such as a browser.

FIG. 2 is an example data set used for collecting and storing NPS data in a given time period. To enable analysis of changes in sample populations, in addition to collecting and storing a respondent's rating score, additional data about the respondent may also be collected. The additional data may include information that is already available to the enterprise. For example, if the respondent is a user of a software program, the software program may have collected data about the user, the user's device, and the like, during a registration process. This data may be stored in a data store associated with and/or accessible to the enterprise and may be retrieved from such data store when the user responds to a customer survey for which changes in NPS may be calculated. It should be noted that in collecting, retrieving, storing and analyzing respondent data, care is taken to ensure the user's privacy is protected.

The retrieved respondent data may be categorized into different dimensions and stored in a columnar structure such as the data structure 200 of FIG. 2. One or more columns of the data structure 200 may represent different dimensions. One of the columns of the data structure may be used to store user IDs that differentiate the respondents from each other. The user ID may be an identification number that does not reveal any private or identifying information. The data structure 200 may also include a column for storing the rating score selected by each user. The rating score may have a predetermined range based on the parameters selected for the survey. For example, the rating score may have a range from 0 to 10. In another example, the rating score may have a range of 0 to 5. Alternatively, the rating score may have a range of 0 to 100.

To calculate the NPS, the rating scores may be categorized as promoters, passives, and detractors. In some implementations, for a rating score range of 0 to 10, promoters may be categorized as respondents that provide a score of 9-10, passives may be categorized as those that provide a score of 7-8, and detractors may be designated as those who provide a score of 1-7. The percentage of detractors may then be subtracted from the percentage of promoters to obtain the NPS.

In addition to the user ID and the rating score, the data structure 200 may include multiple additional columns, each of which may represent a separate dimension for the respondent. For example, the data structure 200 includes a user type, language, OS code name and device manufacturer. Each of these dimensions may have multiple levels. For example, the user type may have a consumer level and a commercial level, while the language level may have a separate level for every language in which the product and/or service is offered (e.g., English, Spanish, French, Chinese, and the like). Similarly, the OS code name and device manufacturer may have many different levels. Depending on the type of product, service, or company for which a survey is being conducted, many different types of dimensions may be available for retrieval and storage. Given that each of these dimensions may have numerous possible levels, the resulting data structure may be a large and complex data structure containing a significantly large amount of data. This data can be analyzed to detect changes in the respondents' population, when evaluating changes in customer ratings.

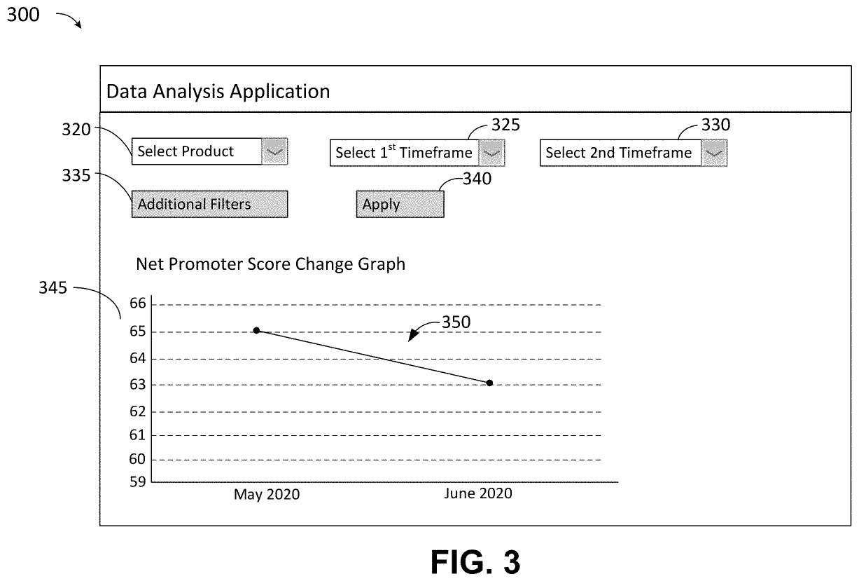

FIG. 3 is an example GUI screen 300 displayed by a data analysis application used to analyze and display customer rating data. GUI screen 300 may be a display screen of a data analysis application which can be used by an administrator of an enterprise to review and analyze customer rating data. In one implementation, the data analysis application communicates with a backend data analysis service, which may be stored in a server, to access customer rating data stored in a data store. The backend service may access the customer rating data (e.g., a data structure such as the data structure 200 of FIG. 2) and perform calculations requested by the user via the GUI screen 300.

It should be noted that in some implementations, all calculations are performed locally by the data analysis application. Moreover, in some implementations, the customer rating data may be stored locally on the client device on which the data analysis application is stored.

Enterprises may conduct customer surveys for multiple products or services. To enable such enterprises to review the results of the various surveys, the GUI screen 300 may include a menu option 320 for selecting the product, service or company for which the survey results will be analyzed and displayed. Furthermore, to enable selection of a specific time period for which survey results are available, a menu option 325 may be provided. When the user desires to review changes in customer ratings over time (e.g., changes in NPS), they may utilize a menu option 330 to select a second time period. When two different time periods are selected via menu options 325 and 330, the data analysis application may calculate and analyze changes in customer rating between the two time periods.

In some implementations, additional filters may be selected via the menu option 335. Once a produce, service, or company has been selected and two time periods have been chosen, the menu option 340 may be used to apply the selected parameters to the customer rating data. In some implementations, the resulting calculations is displayed via a graph such as the graph 345. Alternatively, the results may be displayed via different types of diagrams. In some examples, the results may be displayed via a table. In different implementations, instead of presenting the results on the same GUI screen, the results may be displayed via a different screen (e.g., a pop-up screen). In an example, the value for calculated total NPS change may be displayed alongside the graph 345. It should be noted that the menu options 320, 325, 330, 335 and 340 are only example user interface elements for selecting parameters in performing data analysis on customer rating data. Other types of UI elements are contemplated and may be utilized.

The graph 345 may display a total NPS line 350 that depicts how the total NPS changes over time from the first time period to the second time period. For the example graph 345, the total NPS line 350 illustrates that the total NPS changed from a value slightly above 65 to about 63 (e.g., for a rating scale of 0 to 100).

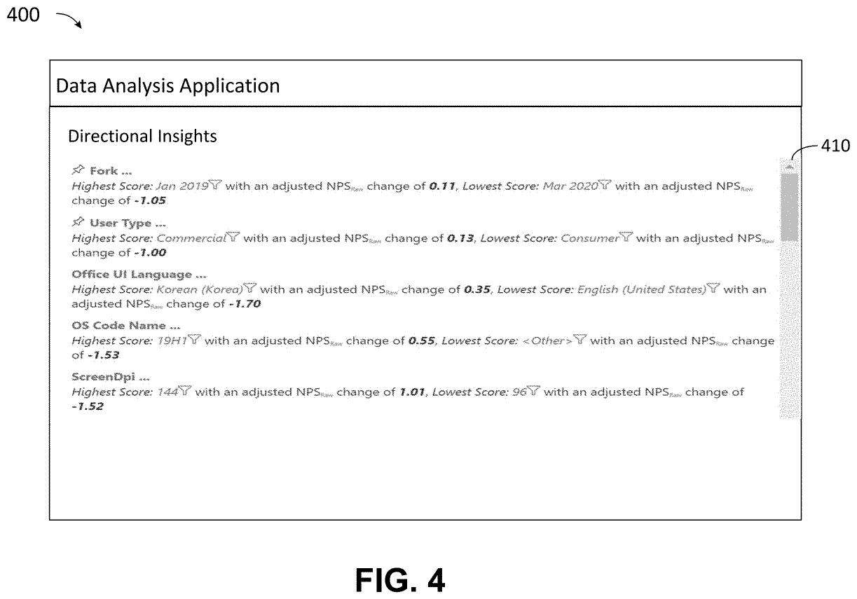

In some implementations, the data analysis application may provide an additional GUI screen such as the one displayed in GUI screen 400 of FIG. 4, to provide more detailed information about changes in customer ratings within different respondent dimensions. In some implementations, the GUI screen 400 is displayed alongside the GUI screen 300 to provide side by side information and analysis. In alternative implementations, the GUI screen 400 may be invoked via a menu option and may be displayed by itself

The GUI screen 400 may display information about changes in customer ratings within different dimensions and the levels in each dimension that had the highest and/or lowest changes. For example, the GUI screen 400 displays that for user type dimensions, commercial users had the highest NPS score with an adjusted NPS change of 0.13 and consumer users had the lowest NPS score with an adjusted NPS change of −1.00. This can quickly show the viewer how the NPS changed within each dimension and how different groups of users within each dimension rated the product. By displaying the adjusted NP change value, instead of the total NPS change value, the display may provide a more accurate picture of NPS changes. For example, the Office UI Language dimension illustrates that Korean speaking users provided the highest rating score, while United States English speakers provided the lowest rating score, and that the adjusted NPS changed more for United States English speakers. When numerous dimensions are available, the user can scan through the list quickly to identify areas of interest. A scroll bar 410 may be provided to enable scrolling through the various dimensions to view highlights for each separate dimension.

In some implementations, the dimensions may be sorted based on the amount of NPS change and/or the amount of adjusted NPS change in the different levels of each dimension. The directional data may then be ordered based on the amount of change, either the total NPS change or adjusted NPS change. For example, dimensions having levels that demonstrated the largest adjusted NPS changes may be displayed at the top of the list, while dimension having the lowest amount of adjusted NPS change may be displayed in the bottom. This may enable quick identification of potential areas of respondent population rating changes. For example, when it is determined that respondents having OS Code Names identified as Other had the largest adjusted NPS change, the underlying data for those users may be examined to determine what factors may have contributed to the change.

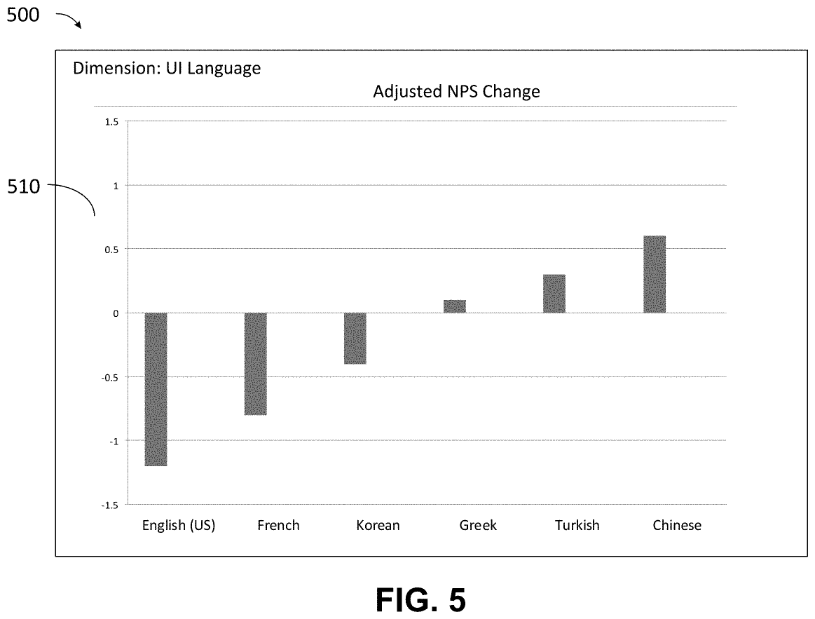

In some implementations, more detailed information about NPS changes within each individual dimension may be provided by a GUI screen such as the GUI screen 500 of FIG. 5. The GUI screen 500 may be accessed by clicking on a dimension in the GUI screen 400. Alternatively, the GUI screen 500 may be displayed by invoking a separate UI element. In some implementations, the GUI screen 500 is overlayed on the GUI screen 400 and/or GUI screen 300 (e.g. a pop-up screen). Once displayed, the GUI screen 500 may depict a diagram of adjusted NPS changes for each of the levels within a dimension. For example, for the UI language dimension, the GUI screen 500 may depict a bar chart 510 which displays the adjusted change in NPS for each of the available languages. This enables a viewer to quickly and efficiently identify which portions of the population contributed to more NPS changes and the direction of that change. For example, a quick review of the bar chart 510 demonstrates that the largest NPS changes occurred for users of the English UI and that the DPS change was a decrease in NPS. This information can provide insights into how the product rating has changed within different portions of the respondent population, and how those populations may have affected the overall change in NPS. Moreover, because the chart displays adjusted NPS change values, the user can trust that the results are representative of true NPS changes and not changes that are a result of sample population changes.

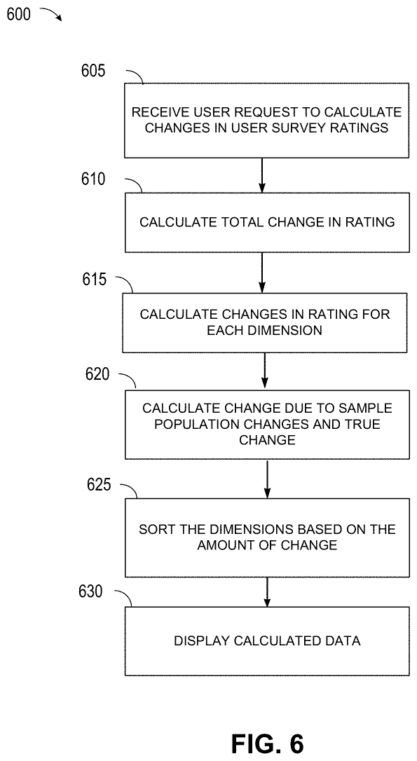

FIG. 6 is a flow diagram depicting an exemplary method 600 for analyzing and displaying changes in user ratings. In an example, one or more steps of method 600 may be performed by a data analysis application (e.g., data analysis application 122 of FIG. 1) and/or a change analysis service (e.g., change analysis service 112 of FIG. 1).

At 605, method 600 may begin by receiving a user request for calculating a change in user ratings of a product, service and/or company. The request may be submitted via a UI element of a data analysis application and may include one or more parameters such as the selection of a product for which survey data is available. The request may also include a selection of two time periods between which the change in ratings should be calculated. In some implementations, the request may include additional filters selected by the viewer.

Once the request is received, method 600 may proceed to use the received parameters (e.g., the requested product, and time periods) to access the data set associated with user ratings for the requested product, service and/or company during the requested time periods. The information in the data sets may then be used to calculate an NPS for each of the given time periods. The overall change in user rating between the two periods may then be calculated, at 610. For two consecutive time periods, this may be achieved by using the following equation:

(Nᵢ₊₁−Nᵢ)=δ (1)

where Nᵢ represents NPS in time period i, Nᵢ₊₁ represents NPS in the next period and δ represents the change in NPS.

In addition to calculating the overall change in rating, method 600 may also proceed to calculate the change in ratings for each dimension of the data set, at 615. This may be done by calculating the change in ratings over a dimension having L levels by utilizing the following algorithm:

Σᵢ₌₁^{L}pᵢ₊₁Nᵢ₊₁−Σᵢ₌₁^{L}pᵢNᵢ (2)

In equation (2), pᵢ is used to represent the proportion of sample size for the L levels of a dimension. This is because the sum of proportions of sample sizes for all the levels within a dimension equals 1 for each period, and the NPS change is dependent on the sample size in each. Using this computational methodology, NPS changes between two time periods due to a change in respondent population proportion can be quantified by analyzing the NPS change one dimension at a time. This can be performed, at 620, by utilizing the following equations.

δ=Σᵢ₌₁^{L}pᵢ₊₁Nᵢ₊₁+Σᵢ₌₁^{L}pᵢ₊₁Nᵢ−Σᵢ₌₁^{L}pᵢ₊₁Nᵢ−Σᵢ₌₁^{L}pᵢNᵢ (3)

δ=Σᵢ₌₁^{L}pᵢ₊₁Nᵢ₊₁−Σᵢ₌₁^{L}pᵢ₊₁Nᵢ+Σᵢ₌₁^{L}pᵢ₊₁Nᵢ−Σᵢ₌₁^{L}pᵢNᵢ (4)

δ=Σᵢ₌₁^{L}pᵢ₊₁(Nᵢ₊₁−Nᵢ)+Σᵢ₌₁^{L}Nᵢ((pᵢ₊₁−pᵢ) (5)

By adding the value of Σᵢ₌₁^{L}pᵢ₊₁Nᵢ, in equation (3), the total NPS change value can be decomposed to changes in value due to sample proportion changes and true NPS changes. Equation (3) can be simplified to equation (4). Further factorization of equation (4) results in the final equation (5). In equation (5), Σᵢ₌₁^{L}pᵢ₊₁(Nᵢ₊₁−Nᵢ) quantifies the true NPS change for a given dimension, while Σᵢ₌₁^{L}Nᵢ(pᵢ₊₁−pᵢ) quantifies the change in NPS due to changes in sample proportion. To do so, equation (5) quantifies the differences in sample size proportions between the two time periods for each of the levels in a given dimension and multiples that value by the NPS in the first time period to arrive at a value for the change in NPS due to changes in sample proportion for each level. The value for the NPS change due to sample portion for each level may then be added together to arrive at the total NPS change due to sample size proportions for each dimension. Similarly, to calculate the true NPS change for each dimension, equation (5) calculates the difference in NPS between the first and the second time periods for each level and multiples that by the proportion sample size at the second time period to arrive at the true NPS change for each level. The value for the true NPS for each of the levels of a given dimensions may then be added together to arrive at the total true NPS change for each dimension. Given that an enterprise often collects user rating data from hundreds or thousands of users and the collected data includes numerous dimensions associated with user ratings and many levels for each of those dimensions, the algorithm may involve processing an enormous amount of data. This can be achieved by utilizing a server such as change analysis service 112 of FIG. 1. Thus, by using the above equations, method 600 can calculate the adjusted NPS for each level of a dimension and an overall NPS adjusted for each dimension.

Once the overall and adjusted NPS changes in each dimension and/or level are calculated, the dimensions may be sorted based on the calculated overall and/or adjusted NPS change, at 625. This may be performed to bring to attention the dimensions that influence the NPS change the most. To achieve this, dimensions having higher overall and/or adjusted NPS values may be positioned at the top of the list. In this manner, the dimensional impact analysis can quickly identify dimensions that have had a higher impact on the NPS for further investigation. In some implementations, the levels that have higher adjusted and/or total NPS changes are also identified, such that information about them can be provided to the viewer.

Once the calculations are performed and the dimensions and/or levels are sorted, the calculated data may be displayed to the user, as requested, at 630. This may be achieved, for example, by transmitting display data containing the calculated data to the client device from which the request was received and then displaying a diagram such as the one depicted in FIG. 3 or by displaying a directional insight screen such as the one displayed in FIG. 4 on the display screen. Additional information may be provided for display as requested by the viewer.

FIG. 7 is a block diagram 700 illustrating an example software architecture 702, various portions of which may be used in conjunction with various hardware architectures herein described, which may implement any of the above-described features. FIG. 7 is a non-limiting example of a software architecture and it will be appreciated that many other architectures may be implemented to facilitate the functionality described herein. The software architecture 702 may execute on hardware such as client devices, native application provider, web servers, server clusters, external services, and other servers. A representative hardware layer 704 includes a processing unit 706 and associated executable instructions 708. The executable instructions 708 represent executable instructions of the software architecture 702, including implementation of the methods, modules and so forth described herein.

The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular system. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine depicted in block diagram 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement methods or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860 and/or position components 862, among a wide array of other environmental sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 862 may include, for example, location sensors (for example, a Global Position System (GPS) receiver), altitude sensors (for example, an air pressure sensor from which altitude may be derived), and/or orientation sensors (for example, magnetometers). The motion components 858 may include, for example, motion sensors such as acceleration and rotation sensors. The environmental components 860 may include, for example, illumination sensors, acoustic sensors and/or temperature sensors.

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 862, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-5) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:

Item 1. data processing system comprising:

a processor; and

a memory in communication with the processor, the memory comprising executable instructions that, when executed by the processor, cause the data processing system to perform functions of:
receiving a request to calculate a value for an amount of change in a parameter associated with user ratings between a first time period and a second time period;
retrieving data from a data structure associated with the user ratings, the data structure including a plurality of dimensions for each user rating and each dimension having one or more levels;
calculating, based on the retrieved data, the value for the amount of change for at least one of the plurality of dimensions;
quantifying, for the calculated value, a first portion resulting from changes in user population proportions and a second portion resulting from true change in the parameter associated with the user ratings; and
providing display data for generating a UI screen to display at least one of the calculated value, the first portion and the second portion on a display device,
wherein quantifying the first portion includes:
   receiving as an input, for each of the one or more levels of the at least one of the plurality of dimensions, the parameter associated with the user rating at the first time period, a first proportion of user population size at the first time period and a second proportion of user population size at the second time period,
   calculating for each of the one or more levels of the at least one of the plurality of dimensions, the first portion by taking into account a change in user population size between the first time period and the second time period, and
   calculating the first portion for the at least one of the plurality of dimensions by taking into the calculated first portion for each of the one or more levels of the at least one of the plurality of dimensions.

Item 2. The data processing system of item 1, wherein the instructions further cause the processor to cause the data processing system to perform functions of:

calculating a total amount of change in user ratings between the first time period and the second time period.

Item 3. The data processing system of item 2, wherein the UI displays a diagram depicting at least one of the total amount of change between the first time period and the second time period, the value of the amount of change for the at least one of the plurality of dimensions, and the second portion.

Item 4. The data processing system of any one of the preceding items, wherein the parameter associated with the user ratings is a Net Promotor Score (NPS).

Item 5. The data processing system of any one of the preceding items, wherein quantifying the second portion includes:
receiving as an input, for each of the one or more levels of the at least one of the plurality of dimensions, a proportion of user population size at the second time period, the parameter associated with the user rating at the first time period, and the parameter associated with the user rating at the second time period,
calculating for each of the one or more levels of the at least one of the plurality of dimensions, the second portion by taking into account a change in a value of the parameter associated with the user rating between the first time period and the second time period, and
calculating the second portion for the at least one of the plurality of dimensions by taking into the calculated second portion for each of the one or more levels of the at least one of the plurality of dimensions.

Item 6. The data processing system of any one of the preceding items, wherein the instructions further cause the processor to cause the data processing system to perform functions of:

sorting the plurality of dimensions based on at least one of the amount of change, the first portion or the second portion.

Item 7. The data processing system of any one of the preceding items, wherein each dimension of the plurality of dimensions is mutually exclusive from other dimensions of the plurality of dimensions.

Item 8. A method for displaying changes in user ratings, comprising:
receiving a request to calculate a value for an amount of change in a parameter associated with user ratings between a first time period and a second time period;
retrieving data from a data structure associated with the user ratings, the data structure including a plurality of dimensions for each user rating and each dimension having one or more levels;
calculating based on the retrieved data the value for the amount of change for at least one of the plurality of dimensions;
quantifying, for the calculated value, a first portion resulting from changes in user population proportions and a second portion resulting from true change in the parameter associated with the user ratings; and
providing display data for generating a user interface (UI) screen to display at least one of the calculated value, the first portion and the second portion on a display device,
wherein quantifying the first portion includes:
   receiving as an input, for each of the one or more levels of the at least one of the plurality of dimensions, the parameter associated with the user rating at the first time period, a first proportion of user population size at the first time period and a second proportion of user population size at the second time period,
   calculating for each of the one or more levels of the at least one of the plurality of dimensions, the first portion by taking into account a change in user population size between the first time period and the second time period, and
   calculating the first portion for the at least one of the plurality of dimensions by taking into the calculated first portion for each of the one or more levels of the at least one of the plurality of dimensions.

Item 9. The method of item 8, further comprising calculating a total amount of change in user ratings between the first time period and the second time period.

Item 10. The method of item 9, wherein the UI displays a diagram depicting at least one of the total amount of change between the first time period and the second time period, the value of the amount of change for the at least one of the plurality of dimensions, and the second portion.

Item 11. The method of any one of items 8-10, wherein each dimension of the plurality of dimensions is mutually exclusive from other dimensions of the plurality of dimensions.

Item 12. The method of any one of items 8-11, wherein the parameter associated with the user ratings is a Net Promotor Score (NPS).

Item 13. The method of any one of items 8-12, further comprising sorting the plurality of dimensions based on at least one of the amount of change, the first portion or the second portion.

Item 14. The method of any one of items 8-13, wherein quantifying the second portion includes:
receiving as an input, for each of the one or more levels of the at least one of the plurality of dimensions, a proportion of user population size at the second time period, the parameter associated with the user rating at the first time period, and the parameter associated with the user rating at the second time period,
calculating for each of the one or more levels of the at least one of the plurality of dimensions, the second portion by taking into account a change in a value of the parameter associated with the user rating between the first time period and the second time period, and
calculating the second portion for the at least one of the plurality of dimensions by taking into the calculated second portion for each of the one or more levels of the at least one of the plurality of dimensions.

Item 15. A non-transitory computer readable medium on which are stored instructions that, when executed, cause a programmable device to:
receive a request to calculate a value for an amount of change in a parameter associated with user ratings between a first time period and a second time period;
retrieve data from a data structure associated with the user ratings, the data structure including a plurality of dimensions for each user rating and each dimension having one or more levels;
calculate based on the retrieved data the value for the amount of change for at least one of the plurality of dimensions;
quantify, for the calculated value, a first portion resulting from changes in user population proportions and a second portion resulting from true change in the parameter associated with the user ratings; and
providing display data for generating a UI screen to display at least one of the calculated value, the first portion and the second portion on a display device,
wherein quantifying the first portion includes:
   receiving as an input, for each of the one or more levels of the at least one of the plurality of dimensions, the parameter associated with the user rating at the first time period, a first proportion of user population size at the first time period and a second proportion of user population size at the second time period,
   calculating for each of the one or more levels of the at least one of the plurality of dimensions, the first portion by taking into account a change in user population size between the first time period and the second time period, and
   calculating the first portion for the at least one of the plurality of dimensions by taking into the calculated first portion for each of the one or more levels of the at least one of the plurality of dimensions.

Item 16. The non-transitory computer readable medium of item 15, wherein the instructions further cause the programmable device to calculate a total amount of change in user ratings between a first time period and a second time period.

Item 17. The non-transitory computer readable medium of item 16, wherein the UI displays a diagram depicting at least one of the total amount of change between the first time period and the second time period, the value of the amount of change for the at least one of the plurality of dimensions, and the second portion.

Item 18. The non-transitory computer readable medium of any one of items 15-17, wherein the parameter associated with the user ratings is a Net Promotor Score (NPS).

Item 19. The non-transitory computer readable medium of any one of items 15-18, the display data displays one or more dimensions from the plurality of dimension having larger second portions at a more visible location on the UI screen.

Item 20. The non-transitory computer readable medium of any one of items 15-19, wherein the instructions further cause the programmable device to sort the plurality of dimensions based on at least one of the amount of change, the first portion or the second portion.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory comprising executable instructions that, when executed by the processor, cause the data processing system to perform functions of:
receiving a request to calculate a value for an amount of change in a parameter associated with user ratings between a first time period and a second time period;
retrieving data from a data structure associated with the user ratings, the data structure including a plurality of dimensions for each user rating and each dimension having one or more levels;
calculating, based on the retrieved data, the value for the amount of change for at least one of the plurality of dimensions;
quantifying, for the calculated value, a first portion resulting from changes in user population proportions and a second portion resulting from true change in the parameter associated with the user ratings; and
providing display data for generating a user interface (UI) screen to display at least one of the calculated value, the first portion and the second portion on a display device,
wherein quantifying the first portion includes:
receiving as an input, for each of the one or more levels of the at least one of the plurality of dimensions, the parameter associated with the user rating at the first time period, a first proportion of user population size at the first time period and a second proportion of user population size at the second time period,
calculating for each of the one or more levels of the at least one of the plurality of dimensions, the first portion by taking into account a change in user population size between the first time period and the second time period, and
calculating the first portion for the at least one of the plurality of dimensions by taking into the calculated first portion for each of the one or more levels of the at least one of the plurality of dimensions.

2. The data processing system of claim 1, wherein the instructions further cause the processor to cause the data processing system to perform functions of:
calculating a total amount of change in user ratings between the first time period and the second time period.

3. The data processing system of claim 2, wherein the UI displays a diagram depicting at least one of the total amount of change between the first time period and the second time period, the value of the amount of change for the at least one of the plurality of dimensions, and the second portion.

4. The data processing system of claim 1, wherein the parameter associated with the user ratings is a Net Promotor Score (NPS).

5. The data processing system of claim 1, wherein quantifying the second portion includes:
receiving as an input, for each of the one or more levels of the at least one of the plurality of dimensions, a proportion of user population size at the second time period, the parameter associated with the user rating at the first time period, and the parameter associated with the user rating at the second time period,
calculating for each of the one or more levels of the at least one of the plurality of dimensions, the second portion by taking into account a change in a value of the parameter associated with the user rating between the first time period and the second time period, and
calculating the second portion for the at least one of the plurality of dimensions by taking into the calculated second portion for each of the one or more levels of the at least one of the plurality of dimensions.

6. The data processing system of claim 1, wherein the instructions further cause the processor to cause the data processing system to perform functions of:
sorting the plurality of dimensions based on at least one of the amount of change, the first portion or the second portion.

7. The data processing system of claim 1, wherein each dimension of the plurality of dimensions is mutually exclusive from other dimensions of the plurality of dimensions.

8. A method for displaying changes in user ratings, comprising:
receiving a request to calculate a value for an amount of change in a parameter associated with user ratings between a first time period and a second time period;
retrieving data from a data structure associated with the user ratings, the data structure including a plurality of dimensions for each user rating and each dimension having one or more levels;
calculating based on the retrieved data the value for the amount of change for at least one of the plurality of dimensions;
quantifying, for the calculated value, a first portion resulting from changes in user population proportions and a second portion resulting from true change in the parameter associated with the user ratings; and
providing display data for generating a user interface (UI) screen to display at least one of the calculated value, the first portion and the second portion on a display device,
wherein quantifying the first portion includes:
receiving as an input, for each of the one or more levels of the at least one of the plurality of dimensions, the parameter associated with the user rating at the first time period, a first proportion of user population size at the first time period and a second proportion of user population size at the second time period,
calculating for each of the one or more levels of the at least one of the plurality of dimensions, the first portion by taking into account a change in user population size between the first time period and the second time period, and
calculating the first portion for the at least one of the plurality of dimensions by taking into the calculated first portion for each of the one or more levels of the at least one of the plurality of dimensions.

9. The method of claim 8, further comprising calculating a total amount of change in user ratings between the first time period and the second time period.

10. The method of claim 9, wherein the UI displays a diagram depicting at least one of the total amount of change between the first time period and the second time period, the value of the amount of change for the at least one of the plurality of dimensions, and the second portion.

11. The method of claim 8, wherein each dimension of the plurality of dimensions is mutually exclusive from other dimensions of the plurality of dimensions.

12. The method of claim 8, wherein the parameter associated with the user ratings is a Net Promotor Score (NPS).

13. The method of claim 8, further comprising sorting the plurality of dimensions based on at least one of the amount of change, the first portion or the second portion.

14. The method of claim 8, wherein quantifying the second portion includes:
receiving as an input, for each of the one or more levels of the at least one of the plurality of dimensions, a proportion of user population size at the second time period, the parameter associated with the user rating at the first time period, and the parameter associated with the user rating at the second time period,
calculating for each of the one or more levels of the at least one of the plurality of dimensions, the second portion by taking into account a change in a value of the parameter associated with the user rating between the first time period and the second time period, and
calculating the second portion for the at least one of the plurality of dimensions by taking into the calculated second portion for each of the one or more levels of the at least one of the plurality of dimensions.

15. A non-transitory computer readable medium on which are stored instructions that, when executed, cause a programmable device to:
receive a request to calculate a value for an amount of change in a parameter associated with user ratings between a first time period and a second time period;
retrieve data from a data structure associated with the user ratings, the data structure including a plurality of dimensions for each user rating and each dimension having one or more levels;
calculate based on the retrieved data the value for the amount of change for at least one of the plurality of dimensions;
quantify, for the calculated value, a first portion resulting from changes in user population proportions and a second portion resulting from true change in the parameter associated with the user ratings; and
providing display data for generating a user interface (UI) screen to display at least one of the calculated value, the first portion and the second portion on a display device,
wherein quantifying the first portion includes:
receiving as an input, for each of the one or more levels of the at least one of the plurality of dimensions, the parameter associated with the user rating at the first time period, a first proportion of user population size at the first time period and a second proportion of user population size at the second time period,
calculating for each of the one or more levels of the at least one of the plurality of dimensions, the first portion by taking into account a change in user population size between the first time period and the second time period, and
calculating the first portion for the at least one of the plurality of dimensions by taking into the calculated first portion for each of the one or more levels of the at least one of the plurality of dimensions.

16. The non-transitory computer readable medium of claim 15, wherein the instructions further cause the programmable device to calculate a total amount of change in user ratings between a first time period and a second time period.

17. The non-transitory computer readable medium of claim 16, wherein the UI displays a diagram depicting at least one of the total amount of change between the first time period and the second time period, the value of the amount of change for the at least one of the plurality of dimensions, and the second portion.

18. The non-transitory computer readable medium of claim 15, wherein the parameter associated with the user ratings is a Net Promotor Score (NPS).

19. The non-transitory computer readable medium of claim 15, the display data displays one or more dimensions from the plurality of dimension having larger second portions at a more visible location on the UI screen.

20. The non-transitory computer readable medium of claim 15, wherein the instructions further cause the programmable device to sort the plurality of dimensions based on at least one of the amount of change, the first portion or the second portion.
